(19) United States
(12) Patent Application Publication
(10) Pub. No.: US 2013/0233356 A1
(43) Pub. Date: Sep. 12, 2013

(54) PROCESS AND APPARATUS FOR TREATING SURFACES OF WAFER-SHAPED ARTICLES

(71) Applicants: Rainer OBWEGER, LIND (AT); Michael BRUGGER, MILLSTATT (AT); Franz KUMNIG, LIESERBRUCKE (AT)

(72) Inventors: Rainer OBWEGER, LIND (AT); Michael BRUGGER, MILLSTATT (AT); Franz KUMNIG, LIESERBRUCKE (AT)

(73) Assignee: LAM RESEARCH AG, VILLACH (AT)

(21) Appl. No.: 13/418,034

(22) Filed: Mar. 12, 2012

(51) Int. Cl. B08B 3/02; B08B 3/04

(52) U.S. Cl. 134/33; 134/149; 134/99.1

(57) ABSTRACT

An apparatus and method for processing wafer-shaped articles comprises an array of nozzles that are stationary in use, and are individually controlled to simulate the action of a moving boom arm without the actual need for such an arm. Preferably three such arrays are provided, for dispensing three different types of liquid at various process stages. The computer control of the nozzle valves may cause only one nozzle of each array to be open at any given time, or may cause a pair of adjacent nozzles to be open simultaneously.

### BACKGROUND OF THE INVENTION

1. Field of the Invention

The invention relates generally to processes and apparatus for treating surfaces of wafer-shaped articles, such as semiconductor wafers, wherein one or more treatment liquids are dispensed onto a surface of the wafer-shaped article.

2. Description of Related Art

Semiconductor wafers are subjected to various surface treatment processes such as etching, cleaning, polishing and material deposition. To accommodate such processes, a single wafer may be supported in relation to one or more treatment fluid nozzles by a chuck associated with a rotatable carrier, as is described for example in U.S. Pat. Nos. 4,903,717 and 5,513,668.

Alternatively, a chuck in the form of a ring rotor adapted to support a wafer may be located within a closed process chamber and driven without physical contact through an active magnetic bearing, as is described for example in International Publication No. WO 2007/101764 and U.S. Pat. No. 6,485,531.

In either type of device, process liquids are dispensed onto one or both major surfaces of the semiconductor wafer as it is being rotated by the chuck. Such process liquids may for example be strong oxidizing compositions such as mixtures of sulfuric acid and peroxide for cleaning surfaces of the semiconductor wafer. Such process liquids typically also include deionized water to rinse the wafer between processing steps, and the deionized water is commonly supplemented with isopropyl alcohol to reduce the surface tension of the rinse liquid on the wafer.

As the dimensions of the semiconductor devices formed on these wafers continue to decrease, new demands are made on the equipment for processing the wafers. Smaller device structures are more susceptible to “pattern collapse” when the surface tension of the rinse liquid or other processing liquid on the wafer is too great, a problem which arises from not only the reduced device dimensions but also from the typically higher aspect ratios that accompany smaller device structures.

These problems are exacerbated by the concurrent trend of increasing wafer diameter. Fabrication plants designed for semiconductor wafers of 200 mm diameter are increasingly giving way to those utilizing semiconductor wafers of 300 mm diameter, and a standard for the next generation of 450 mm wafers has already been developed. As the process liquids travel across larger wafer diameters, the potential increases for variations in the temperature and viscosity of the liquid as a function of distance from the point of dispensing, which can lead to inconsistent process performance.

Conventional wafer processing devices have included dispensing nozzles mounted on a swinging boom arm, so that the point of dispensing can be moved across the surface of the wafer, and have also included plural movable nozzles and showerheads as shown for example in U.S. Pat. Nos. 6,834,440 and 7,017,281 and U.S. Published Patent Appln. No. 2006/0086373. However, these approaches add mechanical complexity to the processing equipment, and, especially in the case of closed process chambers, the moving parts constitute a potential source of particle contamination. Furthermore, they do not necessarily afford sufficient control over the behavior and physical properties of the liquid across the wafer surface.

### SUMMARY OF THE INVENTION

The present inventors have developed improved processes and apparatus for treating wafer-shaped articles, in which at least one array of stationary nozzles is arranged along the radius of a wafer-shaped article, with each of the nozzles being equipped with its own computer-controlled valve.

Thus, the invention in one aspect relates to an apparatus for processing wafer-shaped articles, comprising a rotary chuck adapted to hold a wafer shaped article of a predetermined diameter thereon and to rotate the wafer shaped article about an axis of rotation, and a liquid-dispensing device comprising an array of liquid-dispensing nozzles. The nozzles in a process position of the liquid-dispensing device open adjacent a major surface of a wafer shaped article positioned on the rotary chuck. The array of nozzles extends radially from an innermost nozzle positioned closest to the axis of rotation to an outermost nozzle positioned closest to a periphery of a wafer shaped article positioned on the rotary chuck. The liquid dispensing device further comprises an array of conduits with each of the conduits communicating with a corresponding one of the array of nozzles. Each of the conduits is equipped with a respective computer-controlled valve, such that a flow of liquid through each of the nozzles can be controlled independently of a flow of liquid through any others of the nozzles. The array of nozzles is mounted such that the nozzles when in the process position are not movable relative to one another in a direction perpendicular to the axis of rotation.

In preferred embodiments of the apparatus according to the present invention, the array of liquid-dispensing nozzles comprises at least three liquid dispensing nozzles, preferably 3-7 liquid-dispensing nozzles, more preferably 4-6 liquid-dispensing nozzles, and most preferably 5 liquid-dispensing nozzles.

In preferred embodiments of the apparatus according to the present invention, the liquid dispensing device comprises a plurality of arrays of liquid-dispensing nozzles, wherein each of the arrays of liquid dispensing nozzles extends radially from an innermost nozzle positioned closest to the axis of rotation to an outermost nozzle positioned closest to a periphery of a wafer shaped article positioned on the rotary chuck.

In preferred embodiments of the apparatus according to the present invention, the liquid dispensing device comprises two to four arrays of liquid-dispensing nozzles, and preferably three arrays of liquid-dispensing nozzles.

In preferred embodiments of the apparatus according to the present invention, each of the arrays of liquid-dispensing nozzles is in communication with a respectively different liquid supply.

In preferred embodiments of the apparatus according to the present invention, the innermost nozzle of at least one array of liquid-dispensing nozzles opens on the axis of rotation so as to dispense liquid onto a center of a wafer-shaped article positioned on the rotary chuck.

In preferred embodiments of the apparatus according to the present invention, the apparatus includes a process chamber enclosing the rotary chuck, the process chamber comprising a cover, and wherein the liquid-dispensing device is mounted at least partially in the cover such that the liquid-dispensing nozzles extend into the chamber from the cover in a direction parallel to the axis of rotation.

In preferred embodiments of the apparatus according to the present invention, there is provided a central liquid supply nozzle separate from the liquid-dispensing device, the central liquid supply nozzle opening on the axis of rotation so as to dispense liquid onto a center of a wafer-shaped article positioned on the rotary chuck.

In preferred embodiments of the apparatus according to the present invention, each of the computer-controlled valves is positioned along its respective conduit at a distance from 5 mm-15 mm upstream of an opening of its respective liquid-dispensing nozzle.

In preferred embodiments of the apparatus according to the present invention, at least one of the liquid-dispensing nozzles has a dispensing opening whose diameter differs from a dispensing opening of at least one other of the liquid-dispensing nozzles.

In another aspect, the present invention relates to method for processing wafer-shaped articles, comprising positioning a wafer-shaped article on a rotary chuck, rotating the wafer shaped article about an axis of rotation, and dispensing a first liquid onto a surface of the wafer-shaped article through an array of liquid-dispensing nozzles. The array of nozzles extends radially from an innermost nozzle positioned closest to the axis of rotation to an outermost nozzle positioned closest to a periphery of the wafer shaped article. During the dispensing each of the array of nozzles is individually controlled by a respective computer-controlled valve, such that a flow of liquid through each of the nozzles during the dispensing is controlled independently of a flow of liquid through any others of the nozzles. The nozzles are stationary relative to one another throughout the dispensing.

In preferred embodiments of the method according to the present invention, the dispensing comprises dispensing a first liquid having a same composition through each of the nozzles within the array, with the computer-controlled valves being opened and closed sequentially from the innermost nozzle to the outermost nozzle.

In preferred embodiments of the method according to the present invention, the array of nozzles comprises at least three nozzles, and the dispensing comprises first dispensing the first liquid through the innermost nozzle simultaneously with an adjacent nozzle of the array, while the outermost nozzle remains closed, and subsequently dispensing the first liquid through the outermost nozzle simultaneously with an adjacent nozzle of the array, while the innermost nozzle remains closed.

In preferred embodiments of the method according to the present invention, the array of nozzles comprises at least three nozzles, and the dispensing comprises dispensing the first liquid through only one of the array of nozzles at any given time.

In preferred embodiments of the method according to the present invention, a second liquid is dispensed through a further array of nozzles.

### BRIEF DESCRIPTION OF THE DRAWINGS

Other objects, features and advantages of the invention will become more apparent after reading the following detailed description of preferred embodiments of the invention, given with reference to the accompanying drawings, in which:

FIG. 1 is an explanatory perspective view of one embodiment of the apparatus according to the present invention;

FIG. 2 is an explanatory cross-sectional side view of a process chamber according to a second embodiment of the invention, with the interior cover shown in its first position;

FIG. 3 is an explanatory cross-sectional side view of a process chamber according to the second embodiment of the invention, with the interior cover shown in its second position;

FIGS. 4a, 4b, 4c and 4d are a sequential series of schematic illustrations showing one dispensing sequence according to an embodiment of the present invention;

FIGS. 5a, 5b, 5c and 5d are a sequential series of schematic illustrations showing another dispensing sequence according to an embodiment of the present invention;

FIG. 6 is an explanatory cross-sectional side view of a process chamber according to a third embodiment of the invention, with the interior and exterior covers shown in their first position; and

FIG. 7 is an explanatory cross-sectional side view of a process chamber according to the third embodiment of the invention, with the interior and exterior covers shown in their second position.

### DETAILED DESCRIPTION OF PREFERRED EMBODIMENTS

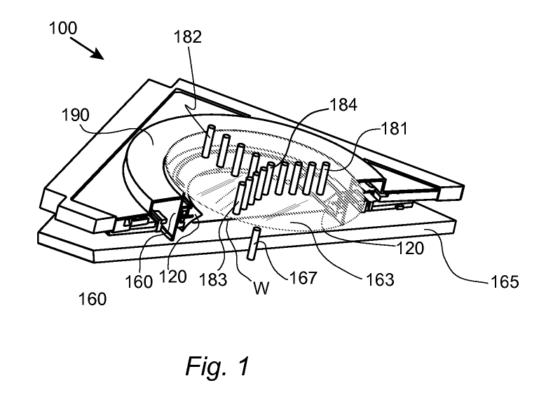

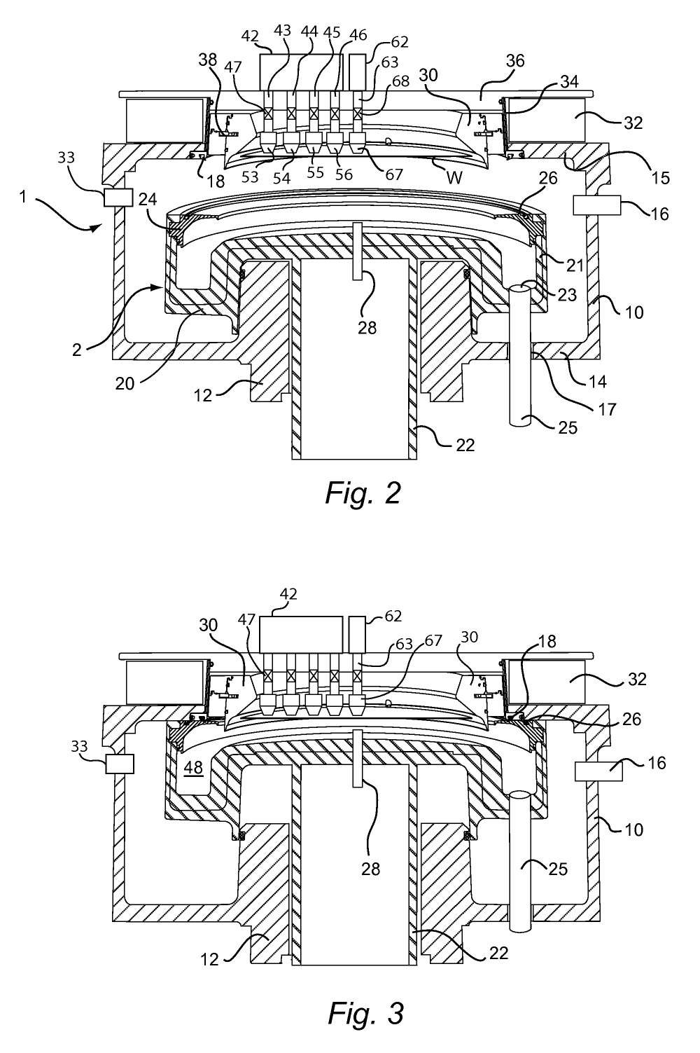

Referring now to FIG. 1, shown therein is an apparatus for treating surfaces of wafer-shaped articles according to a first embodiment of the invention. The overall structure illustrated in FIG. 1 is similar to the apparatus shown in FIGS. 2a-2f of commonly-owned U.S. Patent Application Pub. No. 2011/0253181 (corresponding to WO 2010/113089). In FIG. 1, the device 100 comprises a chamber defined by lower plate 165, upper transparent cover 163, and cylindrical wall 160 extending therebetween. The annular chuck 120 positioned within the chamber is levitated and rotated magnetically in cooperation with a stator surrounding the chamber and enclosed within stator housing 190.

A lower dispensing tube 167 is led through the bottom plate 165 of the chamber. Reference numeral 181 denotes a first array of four radially arranged nozzles for supplying acid (e.g. hydrofluoric acid) to an upper surface of wafer W. Each of nozzles 181 passes through the transparent cover 163 and has an orifice at its lower end opening into the chamber. A second array 182 of four radially arranged nozzles supplies a basic liquid (e.g. ammonia with hydrogen peroxide SC1). A third array 183 array of four radially arranged nozzles supplies deionized water.

Separately from the nozzle arrays 181, 182, 183, a single central nozzle 184 supplies a fourth liquid (e.g. isopropyl alcohol).

The embodiment depicted in FIG. 2 comprises an outer process chamber 1, which is preferably made of aluminum coated with PFA (perfluoroalkoxy) resin. The chamber in this embodiment has a main cylindrical wall 10, a lower part 12 and an upper part 15. From upper part 15 there extends a narrower cylindrical wall 34, which is closed by a lid 36.

A rotary chuck 30 is disposed in the upper part of chamber 1, and surrounded by the cylindrical wall 34. Rotary chuck 30 rotatably supports a wafer W during use of the apparatus. The rotary chuck 30 incorporates a rotary drive comprising ring gear 38, which engages and drives a plurality of eccentrically movable gripping members for selectively contacting and releasing the peripheral edge of a wafer W.

In this embodiment, the rotary chuck 30 is a ring rotor provided adjacent to the interior surface of the cylindrical wall 34. A stator 32 is provided opposite the ring rotor adjacent the outer surface of the cylindrical wall 34. The rotor 30 and stator 34 serve as a motor by which the ring rotor 30 (and thereby a supported wafer W) may be rotated through an active magnetic bearing. For example, the stator 34 can comprise a plurality of electromagnetic coils or windings that may be actively controlled to rotatably drive the rotary chuck 30 through corresponding permanent magnets provided on the rotor. Axial and radial bearing of the rotary chuck 30 may be accomplished also by active control of the stator or by permanent magnets. Thus, the rotary chuck 30 may be levitated and rotatably driven free from mechanical contact. Alternatively, the rotor may be held by a passive bearing where the magnets of the rotor are held by corresponding high-temperature-superconducting magnets (HTS-magnets) that are circumferentially arranged on an outer rotor outside the chamber. With this alternative embodiment each magnet of the ring rotor is pinned to its corresponding HTS-magnet of the outer rotor. Therefore the inner rotor makes the same movement as the outer rotor without being physically connected.

The lid 36 has a manifold 42 mounted on its exterior, which supplies a series of conduits 43-46 that traverse the lid 36 and terminate in respective nozzles 53-56 whose openings are adjacent the upper surface of wafer W. It will be noted that the wafer W in this embodiment hangs downwardly from the rotary chuck 30, supported by the gripping members 40, such that fluids supplied through nozzles 53-56 would impinge upon the upwardly facing surface of the wafer W.

Each conduit 43-46 is equipped with its own valve 47, only one of which is labeled in FIG. 2 for the sake of clarity. Valves 47 are individually computer controlled, as will be described in more detail hereinafter.

A separate liquid manifold 62 supplies liquid to a single central nozzle 67, via conduit 63. Conduit 63 is equipped with its own computer-controlled valve 68.

In case wafer 30 is a semiconductor wafer, for example of 300 mm or 450 mm diameter, the upwardly facing side of wafer W could be either the device side or the obverse side of the wafer W, which is determined by how the wafer is positioned on the rotary chuck 30, which in turn is dictated by the particular process being performed within the chamber 1.

Nozzles 53-56 and 67 may if desired be mounted for axial movement relative to one another and lid 36; however, they are preferably fixed, because movement in the axial direction would confer no particular advantage, and because such movement would constitute a potential source of particulate contamination interiorly of the chamber.

Similarly, nozzles 53-56 may be adjustable as to their radial position when lid 36 is removed from the apparatus 1; however, in their process position illustrated in FIG. 2, they are not movable in the radial direction relative to one another or relative to lid 36. This stationary mounting similarly prevents particulate contamination of the chamber ambient. Moreover, owing to the nozzle configuration and individual valve arrangement according to the present invention, the need for the nozzles to move radially of the wafer W has been eliminated. Although the nozzles 53-56 in FIG. 2 are disposed within the chamber 1, it is also possible that the nozzles be positioned within the lid such that the orifices of the nozzles are flush with the inner surface of lid 36. In that case the associated conduits 43-46 and valves 47 would be positioned outside of the chamber 1, either within lid 36 or above it.

The apparatus of FIG. 1 further comprises an interior cover 2, which is movable relative to the process chamber 1. Interior cover 2 is shown in FIG. 1 in its first, or open, position, in which the rotary chuck 30 is in communication with the outer cylindrical wall 10 of chamber 1. Cover 2 in this embodiment is generally cup-shaped, comprising a base 20 surrounded by an upstanding cylindrical wall 21. Cover 2 furthermore comprises a hollow shaft 22 supporting the base 20, and traversing the lower wall 14 of the chamber 1.

Hollow shaft 22 is surrounded by a boss 12 formed in the main chamber 1, and these elements are connected via a dynamic seal that permits the hollow shaft 22 to be displaced relative to the boss 12 while maintaining a gas-tight seal with the chamber 1.

At the top of cylindrical wall 21 there is attached an annular deflector member 24, which carries on its upwardly-facing surface a gasket 26. Cover 2 preferably comprises a fluid medium inlet 28 traversing the base 20, so that process fluids and rinsing liquid may be introduced into the chamber onto the downwardly facing surface of wafer W.

Cover 2 furthermore includes a process liquid discharge opening 23, which opens into a discharge pipe 25. Whereas pipe 25 is rigidly mounted to base 20 of cover 2, it traverses the bottom wall 14 of chamber 1 via a dynamic seal 17 so that the pipe may slide axially relative to the bottom wall 14 while maintaining a gas-tight seal. An exhaust opening 16 traverses the wall 10 of chamber 1, and is connected to a suitable exhaust conduit (not shown).

The position depicted in FIG. 1 corresponds to loading or unloading of a wafer W. In particular, a wafer W can be loaded onto the rotary chuck 30 either by removing the lid 36, or, more preferably, through a side door 33 in the chamber wall 10. However, when the lid 36 is in position and when side door 33 has been closed, the chamber 1 is gas-tight and able to maintain a defined internal pressure.

In FIG. 2, the interior cover 2 has been moved to its second, or closed, position, which corresponds to processing of a wafer W. That is, after a wafer W is loaded onto rotary chuck 30, the cover 2 is moved upwardly relative to chamber 1, by a suitable motor (not shown) acting upon the hollow shaft 22. The upward movement of the interior cover 2 continues until the deflector member 24 comes into contact with the interior surface of the upper part 15 of chamber 1. In particular, the gasket 26 carried by deflector 24 seals against the underside of upper part 15, whereas the gasket 18 carried by the upper part 15 seals against the upper surface of deflector 24.

When the interior cover 2 reaches its second position as depicted in FIG. 2, there is thus created a second chamber 48 within the closed process chamber 1. Inner chamber 48 is moreover sealed in a gas tight manner from the remainder of the chamber 1.

During processing of a wafer, processing fluids may be directed through nozzles 53-56, 67 and/or 28 to a rotating wafer W in order to perform various processes, such as etching, cleaning, rinsing, and any other desired surface treatment of the wafer undergoing processing.

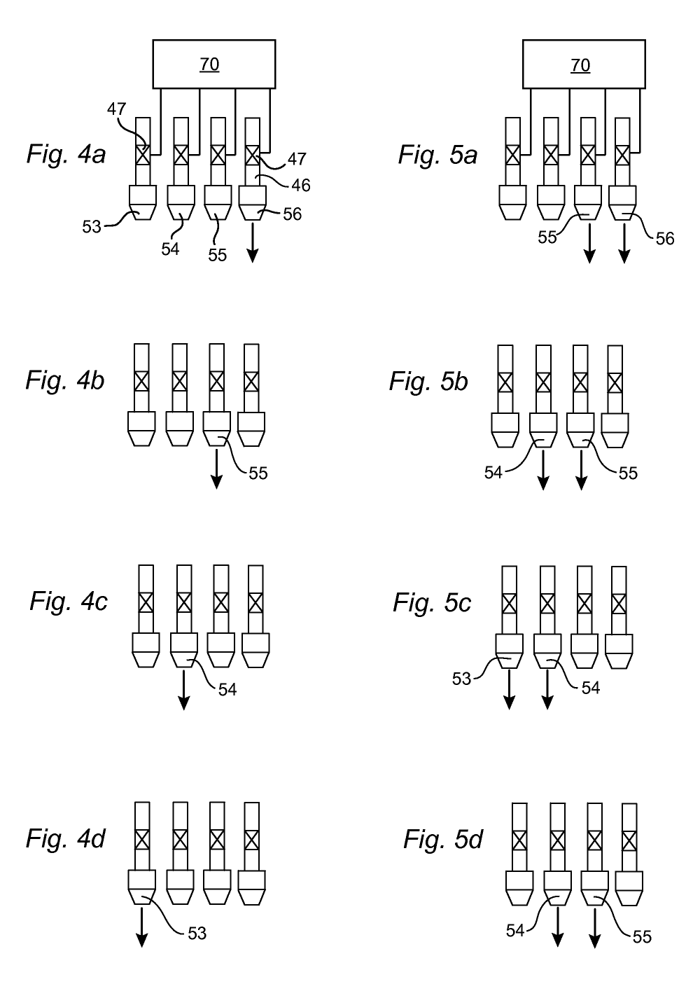

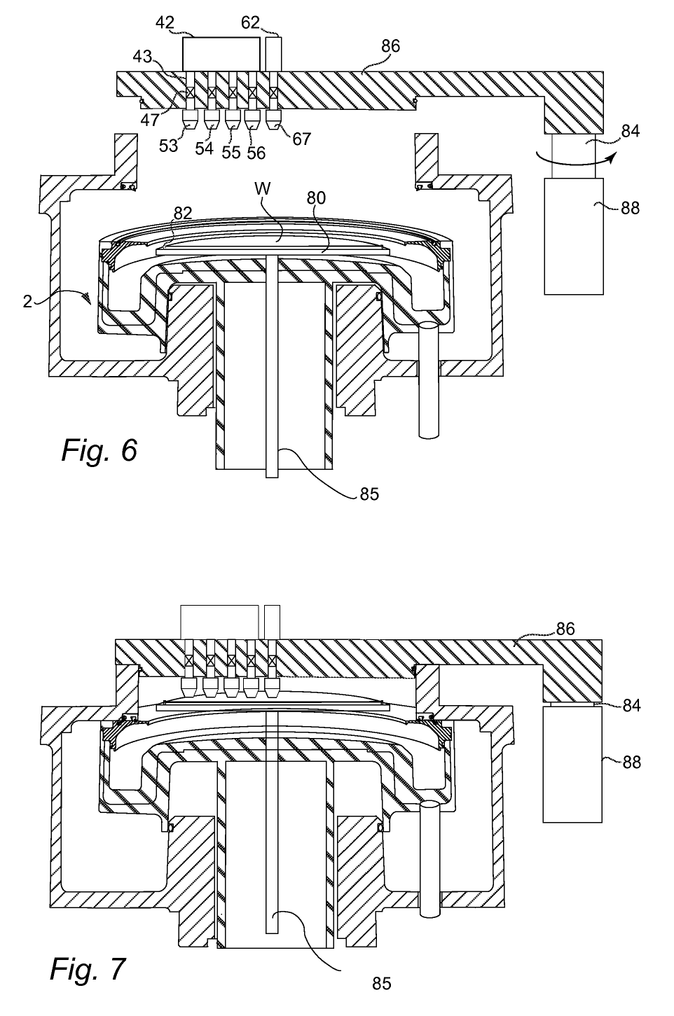

For example, in FIGS. 4a-4d, the valves 47 of nozzles 53-56 are controlled so as to effect a radial sweeping motion of the dispensed liquid across the upper surface of the wafer, as might be achieved with a conventional boom arm, but without the disadvantages associated with a moving nozzle assembly. In FIG. 4a, the valve 47 associated with the radially innermost nozzle 56 is open, whereas the valves 47 associated with nozzles 53-55 are closed. Liquid is therefore dispensed only through nozzle 56. After a predetermined interval, which may be as short as a few milliseconds or as long as a few seconds, the valve 47 for nozzle 56 is closed and the valve 47 for the next adjacent nozzle 55 is almost instantaneously opened, as shown in FIG. 4b. The process is repeated by closing nozzle 55 after a predetermined interval and opening nozzle 54, as shown in FIG. 4c. Next, the radially outermost or peripheral nozzle 53 is opened and nozzle 54 is closed, as shown in FIG. 4d.

The sequence may be repeated in the reverse order to cause “scanning” of the dispensed liquid from the periphery toward the center of the wafer.

An alternative sequence of opening and closing the valves 47 is illustrated in FIGS. 5a-5d, from which it can be seen that the nozzles 53-56 are opened and closed in pairs. That is, the valves 47 for the radially innermost nozzle 56 and the next adjacent nozzles are opened together, as shown in FIG. 5a, while the valves 47 for nozzles 53 and 54 remain closed. Next, the valve for nozzle 56 is closed simultaneously with opening the valve for nozzle 54, while the valve for nozzle 55 remains open (FIG. 5b). The process is repeated so as to open nozzles 53 and 54 (FIG. 5c), whereafter, if desired, the sequence can be reversed as illustrated in FIG. 5d, which is actually the same valve state as in FIG. 5b. This alternative sequence permits “scanning” the wafer surface while contacting a relatively larger area of the wafer at any given time.

The foregoing examples make plain to those skilled in the art that the apparatus and methods according to the present invention permit a wide range of tuning of liquid flows to particular process requirements. That is, by suitable selection of the number of nozzles in the or each array, the diameters of the nozzle orifices, which may the same or different, the duration of valve opening for each nozzle and the extent of overlap, if any, in the opening times of adjacent nozzles, it is possible to achieve a more homogeneous etch result than with conventional devices and techniques. That is, for example, the etch speed (expressed in nm/min or Angstrom/min) may be more nearly the same in the center of the wafer as it is near the edge.

FIGS. 7 and 8 show a third embodiment of the present invention, in which the chamber design of the first embodiment is adapted for use with a spin chuck in which a wafer W is mounted on an upper side of a chuck that is rotated through the action of a motor on a central shaft.

In particular, wafer W is loaded onto spin chuck 80 when interior cover 2 is in the loading/unloading position depicted in FIG. 7, and wafer W is secured in the predetermined orientation relative to chuck 80 by gripping members 82. The chuck 80 is accessed by removal of cover 86, which is movable both vertically and horizontally by translation and rotation of the lid about the hydraulic shaft 84 of motor 88, as shown by the arrow in FIG. 7.

Lid 86 is then rotated back to its position overlying the wafer, and lowered so as to seal the outer chamber, as shown in FIG. 7. Interior cover 2 is then moved to its second position, as shown in FIG. 7 and as described above in connection with the second embodiment, to define the inner chamber 48.

In this embodiment, it will be seen that spin chuck 80 is also vertically moveable relative to the interior cover 2, so that it can be raised to an optimum processing position within the chamber 48. Spin chuck 80 is then rotated by a motor (not shown) acting upon shaft 85.

Alternatively, the lid 86 may be kept open during the liquid supply. In such a case the lid 86 may be replaced by a media arm carrying the array of the plurality of nozzles.

What is claimed is:

1. Apparatus for processing wafer-shaped articles, comprising a rotary chuck adapted to hold a wafer shaped article of a predetermined diameter thereon and to rotate the wafer shaped article about an axis of rotation, and a liquid-dispensing device comprising an array of liquid-dispensing nozzles, wherein said nozzles in a process position of said liquid-dispensing device open adjacent a major surface of a wafer shaped article positioned on said rotary chuck and wherein said array of nozzles extends radially from an innermost nozzle positioned closest to said axis of rotation to an outermost nozzle positioned closest to a periphery of a wafer shaped article positioned on said rotary chuck, said liquid dispensing device further comprising an array of conduits with each of said conduits communicating with a corresponding one of said array of nozzles, wherein each of said conduits is equipped with a respective computer-controlled valve, such that a flow of liquid through each of said nozzles can be controlled independently of a flow of liquid through any others of said nozzles, and wherein said array of nozzles is mounted such that said nozzles when in said process position are not movable relative to one another in a direction perpendicular to said axis of rotation.

2. The apparatus according to claim 1, wherein said array of liquid-dispensing nozzles comprises at least three liquid dispensing nozzles, preferably 3-7 liquid-dispensing nozzles, more preferably 4-6 liquid-dispensing nozzles, and most preferably 5 liquid-dispensing nozzles.

3. The apparatus according to claim 1, wherein said liquid dispensing device comprises a plurality of said arrays of liquid-dispensing nozzles, wherein each array of liquid dispensing nozzles extends radially from an innermost nozzle positioned closest to said axis of rotation to an outermost nozzle positioned closest to a periphery of a wafer shaped article positioned on said rotary chuck.

4. The apparatus according to claim 3, wherein said liquid dispensing devices comprises two to four arrays of liquid-dispensing nozzles, and preferably three arrays of liquid-dispensing nozzles.

5. The apparatus according to claim 3, wherein each of said arrays of liquid-dispensing nozzles is in communication with a respectively different liquid supply.

6. The apparatus according to claim 3, wherein said innermost nozzle of at least one of said arrays of liquid-dispensing nozzles opens on said axis of rotation so as to dispense liquid onto a center of a wafer-shaped article positioned on said rotary chuck.

7. The apparatus according to claim 1, further comprising a process chamber enclosing said rotary chuck, said process chamber comprising a cover, and wherein said liquid-dispensing device is mounted at least partially in said cover such that said liquid-dispensing nozzles extend into said chamber from said cover in a direction parallel to said axis of rotation.

8. The apparatus according to claim 1, further comprising a central liquid supply nozzle separate from said liquid-dispensing device, said central liquid supply nozzle opening on said axis of rotation so as to dispense liquid onto a center of a wafer-shaped article positioned on said rotary chuck.

9. The apparatus according to claim 1, wherein each of said computer-controlled valves is positioned along its respective conduit at a distance from 5 mm-15 mm upstream of an opening of its respective liquid-dispensing nozzle.

10. The apparatus according to claim 1, wherein at least of said liquid-dispensing nozzles has a dispensing opening whose diameter differs from a dispensing opening of at least one other of said liquid-dispensing nozzles.

11. Method for processing wafer-shaped articles, comprising positioning a wafer-shaped article on a rotary chuck, rotating the wafer shaped article about an axis of rotation, and dispensing a first liquid onto a surface of the wafer-shaped article through an array of liquid-dispensing nozzles, wherein said array of nozzles extends radially from an innermost nozzle positioned closest to said axis of rotation to an outermost nozzle positioned closest to a periphery of the wafer shaped article, wherein during said dispensing each of said array of nozzles is individually controlled by a respective computer-controlled valve, such that a flow of liquid through each of said nozzles during said dispensing is controlled independently of a flow of liquid through any others of said nozzles, and wherein said nozzles are stationary relative to one another throughout said dispensing.

12. The method according to claim 11, wherein said dispensing comprises dispensing a first liquid having a same composition through each of said array of nozzles, with said computer-controlled valves being opened and closed sequentially from said innermost nozzle to said outermost nozzle.

13. The method according to claim 11, wherein said array of nozzles comprises at least three nozzles, and wherein said dispensing comprises first dispensing the first liquid through said innermost nozzle simultaneously with an adjacent nozzle of said array, while said outermost nozzle remains closed, and subsequently dispensing the first liquid through said outermost nozzle simultaneously with an adjacent nozzle of said array, while said innermost nozzle remains closed.

14. The method according to claim 11, wherein said array of nozzles comprises at least three nozzles, and wherein said dispensing comprises dispensing the first liquid through only one of said array of nozzles at any given time.

15. The method according to claim 11, further comprising dispensing a second liquid through a further said array of said nozzles.
